(19) United States
(12) Patent Application Publication
(10) Pub. No.: US 2007/0059114 A1
(43) Pub. Date: Mar. 15, 2007

(54) MAGNETIZED COVER FOR MOTOR-DRIVEN TOOLS

(76) Inventor: Thomas D. Grimes II, Arcadia, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/162,351

(22) Filed: Sep. 7, 2005

(51) Int. Cl. B23B 31/02; A45F 5/00; B65D 85/28

(52) U.S. Cl. 408/238; 224/183; 206/379

(57) ABSTRACT

The present invention provides an apparatus and method of removably fixing and carrying workpiece objects on a motor driven tool. A magnetized accessory for the motor driven tool includes a flexible pad configured to conform to at least a portion of an exterior surface of the tool such that the pad does not cover any air flow vent of the tool. A magnet is disposed within the pad and the accessory includes a mechanism for attaching the pad to the exterior surface of the tool. A process for removably fixing and carrying workpiece objects on a motor driven tool includes providing a generally flat, flexible, magnetized pad. The pad is engaged with the tool and a workpiece object is removably attached to the pad.

### BACKGROUND OF THE INVENTION

The present invention generally relates to electric corded or cordless power tools. More particularly, the present invention relates to exterior tool frame covers for removably storing and carrying tool accessories and project hardware.

Hand held power tools are extensively used by most all the professional trades, and by the homeowner-handyman. One of the most useful and common tools is an electric power drill since the drill can be adapted to not only the drilling of holes but also to the driving and removal of screws, the turning of nuts along with the grinding, and the stripping of various surfaces.

Integral to the efficient use of newer drill tools is the concurrent need to access the myriad number of accessories to these tools that have become available in modern times. Where there once were only drill bits and chucks, there are now many more accessories such as flex bits, drill bits, standing tips, and brush tips; many more types of drivers, nut removers, and countersink heads.

Because of the need to access multiple and various accessories for a tool during the course of a single project, there has been great effort expended to devise ways to organize and carry/store the many shaped bits, drills and other hardware in such a way that allows the operator quick and convenient access to those accessories. For example, initial solutions have been off-tool devices such as belt pouches, tool boxes, pockets and carry bags to find the items necessary to continue the job at hand. However, such pouches, pockets and the like are inefficient as they require time to be wasted by someone fishing in waist or other style pouches. A workman may be wearing gloves while doing this and attempting to grasp an object in a pouch or pocket with a gloved hand increases the difficulty in obtaining the object to be retrieved. Sometimes, a workman will have to stop and use both hands to retrieve an object. Other approaches attempted on-tool solutions such as storage bays in the tool case housing, bands, and straps of various widths, material and configurations. However, straps, bands, etc., are limited in their ability to hold a multitude of fasteners and can be difficult to use in carrying oddly shaped project pieces. These straps, bands, etc. are also not operationally convenient since a user operating the motor-driven tool has to take their eyes off of the work at hand in order to place or retrieve an item under or into a band, strap, or belt. This can result in an inefficient loss of work time. Tool straps, bands and belt pouches may be used on multiple tools but straps cannot be transferred without unloading their content and reloading after being strapped down on the next tool. Most bands cannot be attached to many non-tubular shaped tools such as jig saws. Straps, bands, and belts can also be hard to secure on a vibrating round surface where vibrations and the like can cause such straps, bands, belts to fall off. The wearing of work gloves makes it harder to grasp and withdraw small drills or bits when lodged in or under strap-type holders.

Additional solutions have tried to tap the power of the magnet. However, the state of the art in magnetized solutions also fails to fulfill the need. Magnetized devices today are limited by their inability to accommodate or provide for non-ferrous items and also by their inherent problem of flux strength and electric motor placement. Some non-ferrous items are in use with sufficient frequency such that they should be provided for. For example, items such as pencils, glue tubes, and aluminum bit holders are very common and necessary yet, to date no magnetic device has made provision for such items. Magnetic slide-on-trays and small ‘built into the casing’ magnetized zones cannot capture non-ferrous items. Additionally, the aforementioned magnetized solutions do not provide the type of holding power necessary to actually be used in the real world. Slide-on-trays and built-in housing designs are self limiting since, by their design, they cannot provide sufficiently strong flux such that the user can feel secure in using the tool directly overhead, as is oftentimes necessary. Built-into-the-case housing type designs are limited in area and strength because of the need to shield the electric motor from outside magnetic disturbance. They designs provide small non-flexible surfaces that are less receptive to fast, thoughtless object placement because the objects tend to bounce off if the objects are not gently placed on the tray surfaces. Also, slide-on-trays and built-in housing designs provide no accommodation for a transfer to a new tool.

In summary, pouches put one in a blind and disorganized position which is inefficient. Bands, straps and the like cannot carry enough multiple and necessary fasteners and require some concentration to place and retrieve items. The art of magnetized solutions today has only underpowered applications that do not provide for the storage of useful non ferrous items and there has been not provision for the certainty of an operator purchasing a replacement tool at some time and wanting to transfer the capabilities of the magnetic holding areas.

Accordingly, there exists a need for a device for removably fixing and carrying workpiece objects, such as bits, fasteners, drills, and hardware, along with pencils, aluminum and brass accessories in an organized, ready and convenient manner while still providing immediate access to viewable holding areas. A further need exists for a device that provides for transference between tools and is of such holding power so as to be trusted not to release in an untimely fashion. The present invention satisfies these needs and provides other related advantages.

### SUMMARY OF THE INVENTION

The present invention provides an apparatus and method of removably fixing and carrying workpiece objects (e.g., bits, fasteners, drills, hardware, pencils, aluminum and brass accessories, etc.) on a motor driven tool. The apparatus and method provide for transference between tools and the apparatus holds workpiece objects with such power so as to be trusted not to release in an untimely fashion.

An embodiment of the present invention is in the form of a magnetized accessory for a motor driven tool that includes a flexible pad configured to conform to at least a portion of an exterior surface of the tool such that the pad does not cover any air flow vent of the tool. A magnet is disposed within the pad and the accessory includes a mechanism for attaching the pad to the exterior surface of the tool.

The magnet comprises a plurality of magnets distributed throughout the pad. The magnet(s) is sized to generate a hi-flux magnetic holding force over surfaces of the pad.

In one particular illustration, the pad is in the form of a T-shaped body.

The accessory includes a mechanism for holding non-magnetically attractive objects on the pad. The holding mechanism has a plurality of flexible storage loops connected to the pad. At least two of the loops have different diameters to accommodate non-magnetically attractive workpiece objects of various dimensions. The flexible loops are adjustable.

The attaching mechanism can in a number of forms. For example, the magnet can be used as the attaching mechanism. In another example, the attaching mechanism can use hook and loop fasteners.

Another embodiment of the present invention is in the form of a process for removably fixing and carrying workpiece objects on a motor driven tool. The process includes providing a generally flat, flexible, magnetized pad. The pad is engaged with the tool and a workpiece object is removably attached to the pad.

In the process, the providing step also includes the step of attaching a plurality of flexible storage loops to the pad for holding non-ferrous objects on the pad. The providing step further includes the step of disposing a magnet within the pad to provide a magnetic holding area on the pad. The disposing step likewise includes the step of sizing the magnet to generate a hi-flux magnetic holding force over a surface of the pad. The providing step additionally includes the step of shaping the pad to keep the pad from covering any air flow vent of the tool.

The engaging step further includes the step of conforming the pad to an exterior surface of the tool. The engaging step also includes the step of magnetically connecting the pad to an exterior surface of the tool.

The removably attaching step includes the step of distributing a plurality of magnets throughout the pad for magnetically holding a workpiece object on the pad. The removably attaching step also includes the step of connecting a plurality of flexible storage loops to the pad for holding non-magnetically attractive workpiece objects on the pad. The connecting step includes the step of providing at least two of the loops with different diameters to accommodate non-magnetically attractive workpiece objects of various dimensions.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a motor-driven tool engaged to an accessory in accordance with an embodiment of the invention shown with ferrous and non-ferrous workpieces connected to the accessory;

FIG. 2 is a perspective view of an accessory in accordance with an embodiment of the invention;

FIG. 3 is a perspective view illustrating the accessory of FIG. 2 being conformed to the shape of an exterior surface of the tool so as to engage the tool as shown in FIG. 1;

FIG. 4 is a perspective view illustrating the accessory of FIG. 2 being rolled between a relatively flat configuration to a curved configuration;

FIG. 5 is a top plan view of a generally T-shaped accessory in accordance with an embodiment of the present invention;

FIG. 6 is a top plan view of a generally hour-glass shaped accessory in accordance with an embodiment of the present invention;

FIG. 7 is a side elevational cross-sectional view of the accessory of FIG. 5, taken along line 7-7 of FIG. 5; and

FIG. 8 is a blown-up section of the accessory of FIG. 7.

### DETAILED DESCRIPTION OF THE PREFERRED EMBODIMENTS

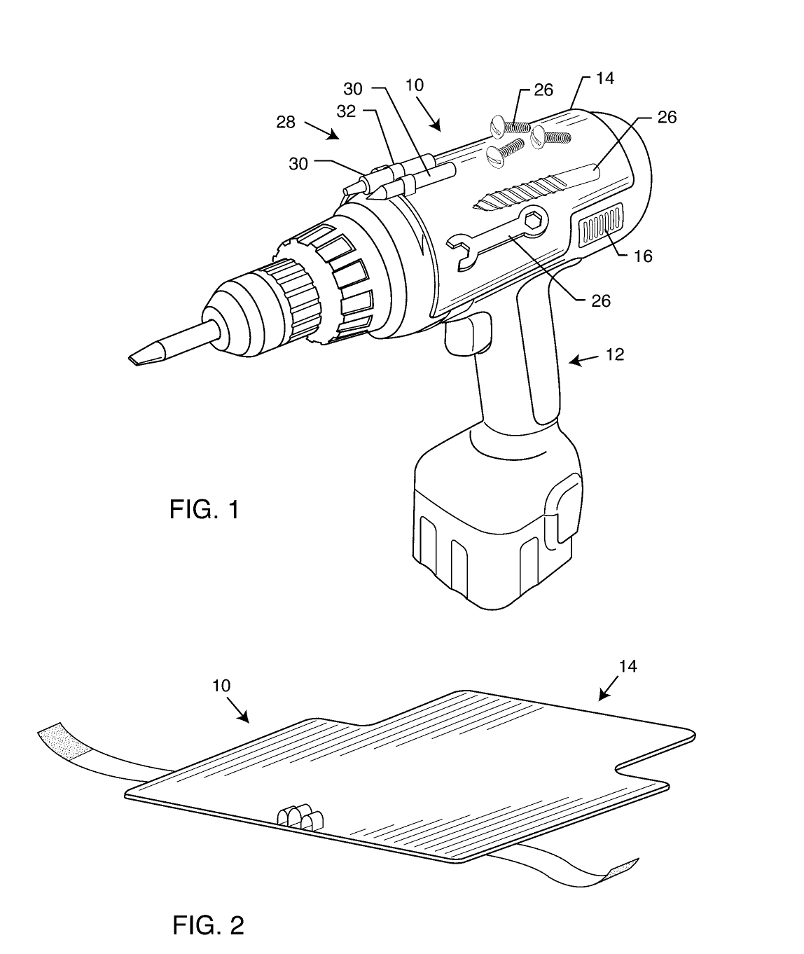

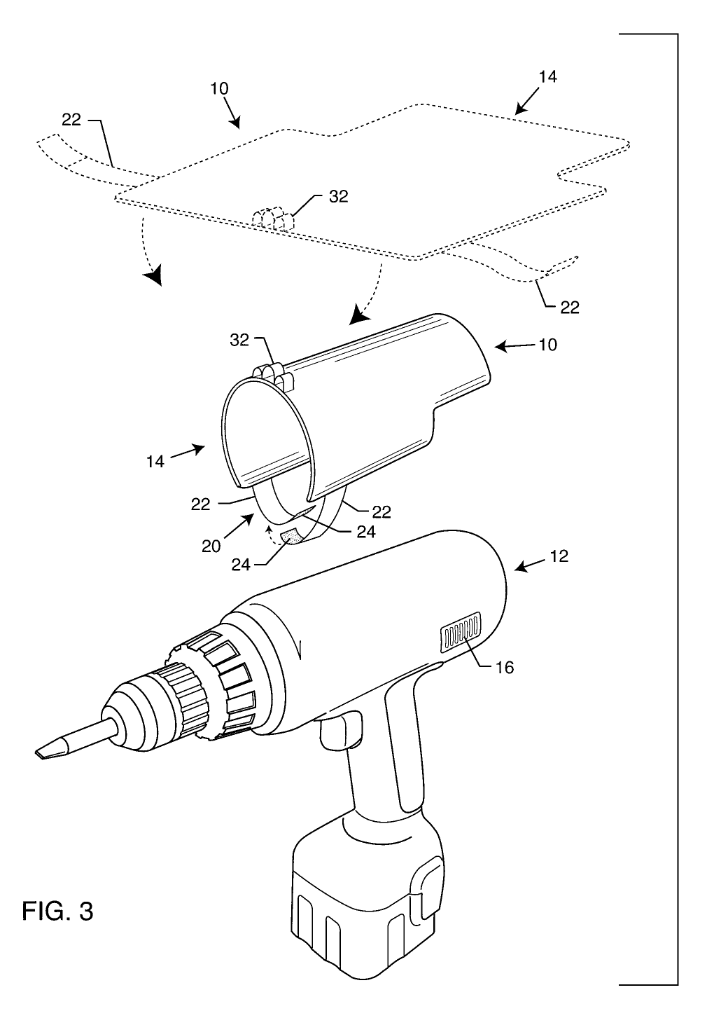

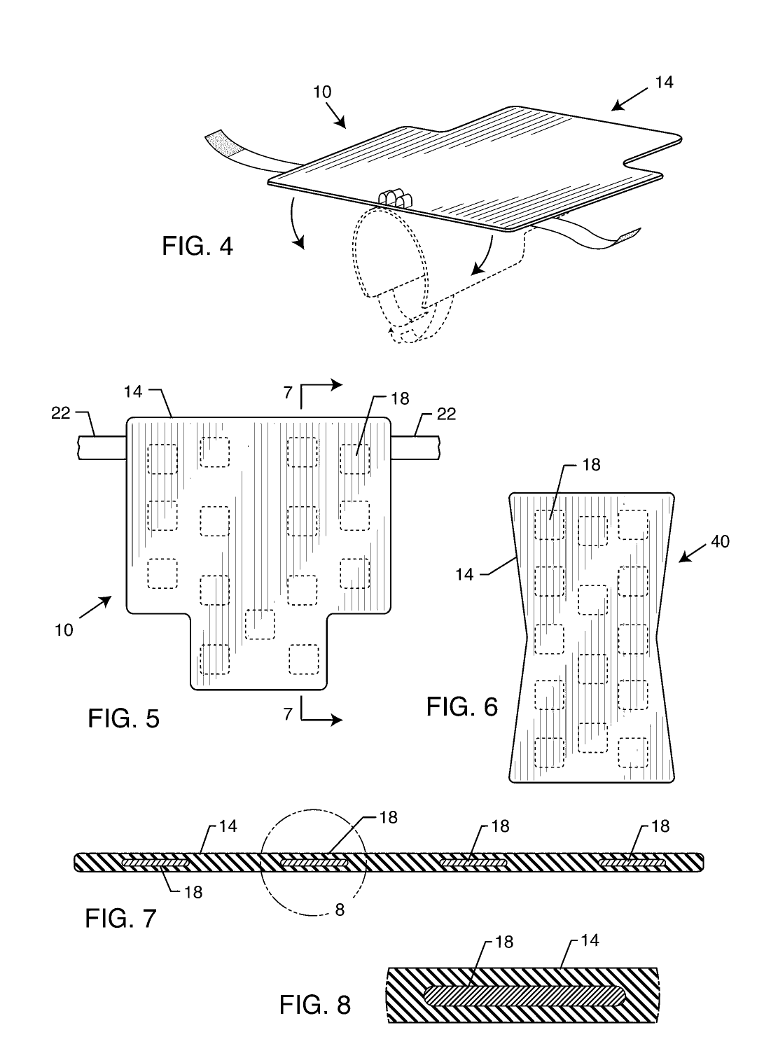

As shown in FIGS. 1-5, 7 and 8, for purposes of illustration, an embodiment of the present invention resides in the form of a magnetized accessory 10 for a motor driven tool 12 (e.g., a cordless power drill) that includes a flexible pad 14 configured to conform to at least a portion of an exterior surface of the tool 12 such that the pad 14 does not cover any air flow vent 16 with an aperture on the housing of the tool 12 (e.g., heat vent, intake valves, etc.). The pad 14 is magnetized in that at least one magnet 18 is disposed within the pad 14. The accessory 10 includes a means 20 for attaching the pad 14 to the exterior surface of the tool 12.

The pad 14 is thin, relatively flat, flexible, soft and cuttable shell that allows the pad 14 to be adaptable to all tools almost as a second skin. The pad 14 can be formed into a variety of shapes and, as shown, is in the form of a T-shaped body, as seen in FIGS. 1-5. As the pad 14 is cuttable, the shapes can be further adapted to meet the particular needs of attaching the accessory 10 to a particular tool. The pad 14 is made out of a variety of materials including, without limitation, a thin leather or vinyl like material.

The magnet 18 may be in the form of a flat magnetic layer in the pad 14 or a plurality of flat magnets 18 embedded within and distributed at intervals throughout the interior of the pad 14, as shown in the figures, to provide a magnetic holding area on the exterior surface of the pad 14. The magnet(s) 18 are size engineered and computer placed in arrangement so as to generate a hi-flux magnetic holding force over surfaces of the pad 14. The magnet(s) 18 also serves as a means for allowing various magnetically attractive and ferrous workpiece objects 26 to be held on the pad 14. These objects 26 include, without limitation, bits, fasteners (e.g., screws, nails, nuts, bolts, washers, etc.), drills, and tools (e.g., wrenches, screwdrivers, etc.). The magnetic force of the magnet(s) 18 allows the objects 26 to be held securely on the surface of the pad 14 which forms a large magnetic holding area. This area is large enough so as to carry numerous fasteners, screws, nuts, bolts, washers and hardware in an open and easily accessible manner. The magnetic holding area provides a place to lay out disassembled parts in an order to sequence to lessen the chance that someone mixes up screws or the like as that person assembles/re-assembles something.

The attaching means 20 can be in a variety of forms including, without limitation, the magnet(s) 18 being used to magnetically connect the accessory 10 to the tool 12. In another example, the attaching mean 20 can use a pair of straps 22 with fasteners 24 on the ends of the straps 22. The fasteners 24 can come in many forms including, without limitation, hook and loop fasteners, snaps, buckle and holes or the like. The straps 22 are wrapped around a portion of the tool 12, as seen in FIGS. 1-3, and then fastened together by the fasteners 24. In the alternative, the straps 22 may also include a device (not shown) to help cinch the straps 22 even tighter around the tool 12. The attachment means 20 can also be permanent by attaching the pad 14 to the tool 12 using a variety of adhesives, epoxies or the like. Each attaching means 20 described above can be used alone or in combination. For example, as seen in FIG. 1, the straps 22 and fasteners 24 may be holding the accessory 10 to the tool 12 alone or, if the exterior of the tool 12 is made of a magnetically attractive material, such as a ferrous material, the magnet(s) 18 assist in connecting the accessory 10 to the tool 12. Likewise, if there were no straps 22 connected to the pad 14, the magnet(s) 18 alone would connect the pad 14 to the ferrous material of the tool 12. The magnet(s) 18 also allow the accessory 10 to be used as a magnetic retriever to reach down and recover an object, such as a screw, that has dropped into a hard to reach place.

The accessory 10 also includes a means 28 for holding non-magnetically attractive or non-ferrous objects 30 on the pad 14. These objects 30 include, without limitation, non-ferrous aluminum bit holders, brass items, plastic glue tubes, wood pencils, and other types of plastic tubes or hardware.

The holding means 28 comprises one or more flexible, resiliently elastic storage loops 32 connected to a portion of the exterior of the pad 14. The loops 32 can be placed anywhere on the exterior of the pad 14 but placing the loops 32 along the edges of the pad 14 allows the magnetic holding area of the pad 14 to be maximized. The loops 32 are shown linearly arranged in sine wave shapes along the edge of the pad 14 but the loops 32 may be spread out or placed along different edges of the pad 14. At least two of the loops 32 have different sizes (i.e., diameters) to accommodate non-magnetically attractive workpiece objects 30 of various dimensions. The resilient elasticity of each of the flexible loops allows the loops 32 to be even further adjustable so as to accommodate a range of dimensions and shapes. Thus, the accessory 10 allows a tool operator to use the outer frame area of the tool 12 to easily load, conveniently carry, and to quickly and efficiently access needed accessories such as bits, drills, fasteners and other hardware.

As seen in FIG. 6, slightly different shapes and configurations of the pads 14 are envisioned and would be used to obtain the most efficient flux area possible for different brands of drivers (i.e., tools) and for different sizes of drivers (i.e., tools) of the same brand. FIG. 6 illustrates another embodiment of the present invention in the form of an hour-glass shaped accessory 40, similar to the accessory 10 described above. Other embodiments may be in various shapes including, without limitation, square, rectangular, oval, circular, diamond, triangular or the like. The pad 14 can attach in multiple ways and as the material of the pad 14 is cuttable, the aforementioned shapes may be further refined, if necessary, to meet the tool's shape or be custom attached for an operator's special need or preference.

Although the accessories 10, 40 have been discussed in terms of their use on a drill, the accessories 10, 40 are not limited to use on a drill and can be adapted and customized to use on all makes and models of hand drills and other hand tools. The accessories 10, 40 can be transferred between similar hand tools (e.g., between different types of drills) or entirely different hand tools (e.g., between a drill and a jig saw). The accessories 10, 40 can be decorated with company logos, alpha-numeric text, graphical indicia or the like.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. A magnetized accessory for a motor driven tool, comprising:
a flexible pad configured to conform to at least a portion of an exterior surface of the tool such that the pad does not cover any air flow vent of the tool;
a magnet disposed within the pad; and
means for attaching the pad to the exterior surface of the tool.

2. The accessory of claim 1, wherein the magnet comprises a plurality of magnets distributed throughout the pad.

3. The accessory of claim 1, wherein the pad comprises a T-shaped body.

4. The accessory of claim 1, including means for holding non-magnetically attractive objects on the pad.

5. The accessory of claim 4, wherein the holding means comprises a plurality of flexible storage loops connected to the pad.

6. The accessory of claim 5, wherein at least two of the loops have different diameters to accommodate non-magnetically attractive workpiece objects of various dimensions.

7. The accessory of claim 5, wherein the flexible loops are adjustable.

8. The accessory of claim 1, wherein the attaching means comprises the magnet.

9. The accessory of claim 1, wherein the attaching means includes hook and loop fasteners.

10. The accessory of claim 1, wherein the magnet is sized to generate a hi flux magnetic holding force over surfaces of the pad.

11. A process for removably fixing and carrying workpiece objects on a motor driven tool, comprising:
providing a generally flat, flexible, magnetized pad;
engaging the pad with the tool; and
removably attaching a workpiece object to the pad.

12. The process of claim 11, wherein the providing step includes the step of attaching a plurality of flexible storage loops to the pad for holding non-ferrous objects on the pad.

13. The process of claim 11, wherein the providing step includes the step of disposing a magnet within the pad to provide a magnetic holding area on the pad.

14. The process of claim 13, wherein the disposing step includes the step of sizing the magnet to generate a hi flux magnetic holding force over a surface of the pad.

15. The process of claim 11, wherein the providing step includes the step of shaping the pad to keep the pad from covering any air flow vent of the tool.

16. The process of claim 11, wherein the engaging step includes the step of conforming the pad to an exterior surface of the tool.

17. The process of claim 11, wherein the engaging step includes the step of magnetically connecting the pad to an exterior surface of the tool.

18. The process of claim 11, wherein the removably attaching step includes the step of distributing a plurality of magnets throughout the pad for magnetically holding a workpiece object on the pad.

19. The process of claim 11, wherein the removably attaching step includes the step of connecting a plurality of flexible storage loops to the pad for holding non-magnetically attractive workpiece objects on the pad.

20. The process of claim 19, wherein the connecting step includes the step of providing at least two of the loops with different diameters to accommodate non-magnetically attractive workpiece objects of various dimensions.
